(19) United States
(12) Patent Application Publication
(10) Pub. No.: US 2026/0148915 A1
(43) Pub. Date: May 28, 2026

(54) SWITCHGEAR

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Satoshi MARUSHIMA, Kawasaki Kanagawa (JP); Yoshiaki OHDA, Yokohama Kanagawa (JP); Tsuyoshi MATSUMOTO, Ota Tokyo (JP); Takanori IIJIMA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 19/266,692

(22) Filed: Jul. 11, 2025

(30) Foreign Application Priority Data
Nov. 27, 2024 (JP) 2024-206207

(51) Int. Cl. H01H 33/666

(52) U.S. Cl. CPC H01H 33/666; H01H 2033/6667

(57) ABSTRACT

In a switchgear of the embodiment, a transmitting mechanism transmits a driving force of an operating mechanism to a second contact part through a first contact part to make the second contact part approach the first contact part when executing a closing operation and make the second contact part separate from the first contact part when executing an opening operation. The transmitting mechanism has a reversing lever, a connecting link, and a fulcrum lever. A reversing lever one end part is rotatably connected to the second contact part. A reversing lever other end part and a connecting link one end part are rotatably connected. A connecting link other end part is rotatably connected to the first contact part. A fulcrum lever one end part is rotatably connected to an airtight container. A fulcrum lever other end part is rotatably connected to a reversing lever fulcrum part.

### CROSS REFERENCE TO RELATED APPLICATIONS

This application is based upon and claims the benefit of priority from Japanese Patent Application No. 2024-206207, filed on Nov. 27, 2024, the entire contents of which are incorporated herein by reference.

### FIELD

Embodiments described herein relate generally to a switchgear.

### BACKGROUND

A switchgear is installed in a power system and is used to interrupt fault currents, small leading currents, lagging load currents such as those caused by reactor switching, and other currents in the power system.

The switchgear is, for example, a puffer-type gas-blast circuit breaker, in which a movable-side contact part and an opposite-side contact part are oppositely arranged inside an airtight container filled with arc-extinguishing gas. The switchgear is configured to execute a closing operation (turn-on operation) and an opening operation (interruption operation) by driving the movable-side contact part. The movable-side contact part includes a movable-side arc contact and a movable-side energizing contact, and the opposite-side contact part includes an opposite-side arc contact and an opposite-side energizing contact.

In the gas-blast circuit breaker, when the closing operation is executed, the movable-side arc contact and the opposite-side arc contact are brought into contact, the movable-side energizing contact and the opposite-side energizing contact are brought into contact, and an electric circuit is energized (turned on). In the gas-blast circuit breaker, when the opening operation is executed, the opposite-side arc contact and the movable-side arc contact separate from each other, the opposite-side energizing contact and the movable-side energizing contact separate from each other, and the electric circuit becomes interrupted. In the puffer-type gas-blast circuit breaker, during an interruption process that brings the electric circuit from the energized state to the interruption state in the opening operation, the arc-extinguishing gas is sprayed on arc discharge that occurs between the opposite-side arc contact and the movable-side arc contact, and the arc discharge is extinguished. This leads to interruption at a current zero point.

An operating mechanism that drives the movable-side contact part is, for example, a spring operating mechanism that uses a spring force. Compared to a hydraulic operating mechanism, the spring operating mechanism is easier to maintain and more reliable but has lower driving energy. Therefore, when the spring operating mechanism is used, it is necessary to reduce the size and weight of the movable-side contact part to perform operations such as interruption and turning on at high speeds.

To execute the operation at high speed with low driving energy, a technology has been proposed to connect the movable-side contact part and the opposite-side contact part by a transmitting mechanism and to transmit the driving energy to execute the operation to the opposite-side contact part together with the movable-side contact part. In this case, the transmitting mechanism causes the opposite-side contact part to move in an opposite direction to a moving direction of the movable-side contact part, thus speeding up the operation of the switchgear.

However, a driving force used to drive the opposite-side contact part is used to move the opposite-side contact part but may act in a direction perpendicular to a moving direction of the opposite-side contact part. Therefore, due to a component in the direction perpendicular to the moving direction of the opposite-side contact part, frictional forces of sliding portions of the movable and opposite-side contact parts may increase, making smooth operation difficult. As a result, it may be difficult to speed up the operation of the switchgear.

Therefore, the problem to be solved by the present invention is to provide a switchgear that can easily achieve high-speed operation.

### BRIEF DESCRIPTION OF THE DRAWINGS

FIG. 1A is a sectional view schematically illustrating a configuration of a switchgear according to a first embodiment (closed state (energized state)).

FIG. 1B is a sectional view schematically illustrating a state when an opening operation (interruption operation) is executed in the switchgear according to the first embodiment (interruption process).

FIG. 1C is a sectional view schematically illustrating a state when the opening operation (interruption operation) is executed in the switchgear according to the first embodiment (open state (interruption state)).

FIG. 2A is a sectional view schematically illustrating a configuration of a switchgear according to a second embodiment (closed state (energized state)).

FIG. 2B is a sectional view schematically illustrating a state when the opening operation (interruption operation) is executed in the switchgear according to the second embodiment (interruption process).

FIG. 2C is a sectional view schematically illustrating a state when the opening operation (interruption operation) is executed in the switchgear according to the second embodiment (open state (interruption state)).

### DETAILED DESCRIPTION

A switchgear of an embodiment includes: an airtight container, a first contact part, a second contact part, an operating mechanism, and a transmitting mechanism, and executes a closing operation that brings an electric circuit from an open state to a closed state and an opening operation that brings the electric circuit from the closed state to the open state. The first contact part is housed inside the airtight container. The second contact part is installed in line opposite the first contact part inside the airtight container. The operating mechanism drives the first contact part such that the first contact part approaches the second contact part when executing the closing operation and the first contact part is separated from the second contact part when executing the opening operation. The transmitting mechanism transmits the driving force of the operating mechanism to the second contact part through the first contact part such that the second contact part approaches the first contact part when executing the closing operation and the second contact part is separated from the first contact part when executing the opening operation. The transmitting mechanism has a reversing lever, a connecting link, and a fulcrum lever. The reversing lever includes a reversing lever one end part, a reversing lever other end part located opposite the reversing lever one end part, and a reversing lever fulcrum part located between the reversing lever one end part and the reversing lever other end part. The connecting link includes a connecting link one end part and a connecting link other end part located opposite the connecting link one end part. The fulcrum lever includes a fulcrum lever one end part and a fulcrum lever other end part located opposite the fulcrum lever one end part. The reversing lever one end part is rotatably connected to the second contact part. The reversing lever other end part and the connecting link one end part are rotatably connected. The connecting link other end part is rotatably connected to the first contact part. The fulcrum lever one end part is rotatably connected to the airtight container. The fulcrum lever other end part is rotatably connected to the reversing lever fulcrum part.

### First Embodiment

### [A] Configuration of Switchgear

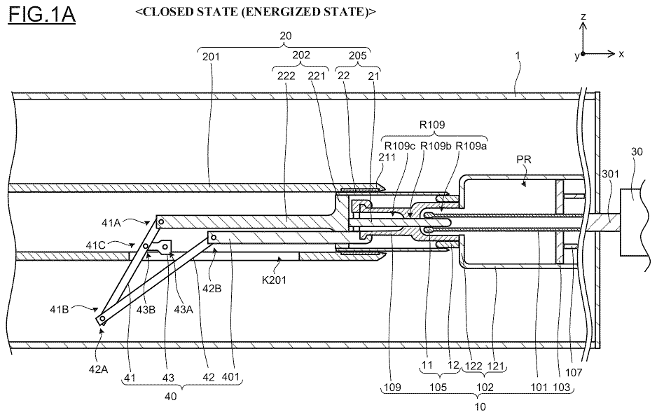

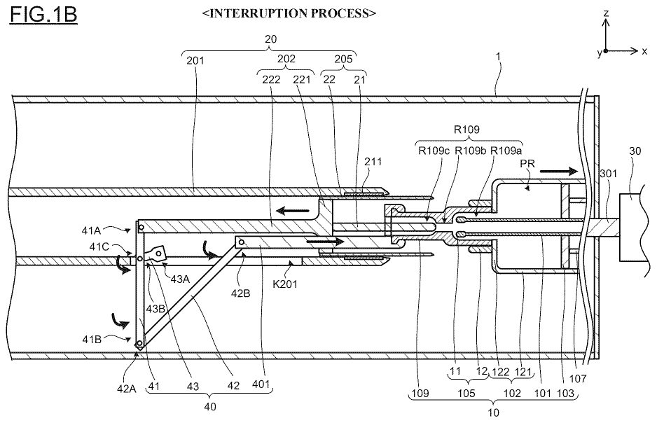

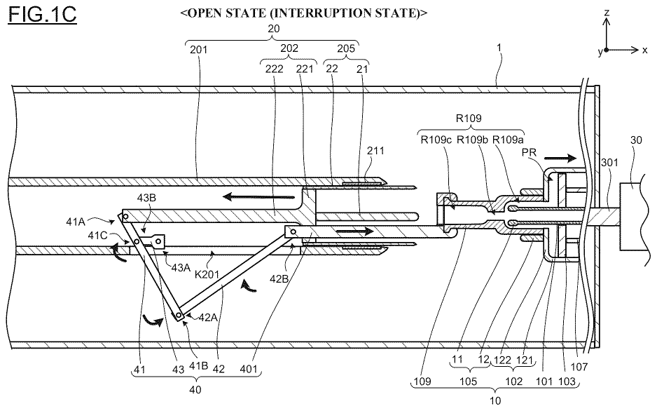

FIG. 1A is a sectional view schematically illustrating a configuration of a switchgear in a first embodiment. In FIG. 1A, a longitudinal direction is a direction z, a horizontal direction is a direction x, and a direction vertical to a paper sheet is a direction y, which is perpendicular to the direction z and the direction x. In FIG. 1A, a state when the switchgear is in a closed state (energized state) is illustrated.

As illustrated in FIG. 1A, the switchgear of this embodiment is a puffer-type gas-blast circuit breaker having an airtight container 1, a movable-side unit 10, an opposite-side unit 20, an operating mechanism 30, and a transmitting mechanism 40. The switchgear of this embodiment is configured in such a way that each part executes a closing operation to bring an electric circuit from an open state (interruption state) to a closed state (energized state), and an opening operation to bring the electric circuit from the closed state to the open state. Each part of the switchgear is sequentially explained.

### [A-1] Airtight Container 1

The airtight container 1 is formed of a metal material and is grounded. Although not illustrated in the figure, each of a pair of electric wires forming an electric circuit is connected to each of the movable-side unit 10 and the opposite-side unit 20 in the airtight container 1. Each of the pair of electric wires is supported by each of a pair of spacers, and the spacers electrically insulate between each electric wire and the airtight container 1.

An inside of the airtight container 1 is filled with arc-extinguishing gas. Here, the arc-extinguishing gas is a gas with excellent arc-extinguishing and insulating properties, such as sulfur hexafluoride gas (SF₆ gas), air, carbon dioxide, oxygen, nitrogen, or a mixture of the above gases, for example. The arc-extinguishing gas preferably has a lower global warming potential and a smaller molecular weight than sulfur hexafluoride gas and is a gas that is in a gas phase at least at 1 atm or more and 20 degrees Celsius or less.

### [A-2] Movable-Side Unit 10

The movable-side unit 10 is housed inside the airtight container 1. The movable-side unit 10 includes an operating rod 101, a cylinder 102, a piston 103, a movable-side contact part 105, and an insulating nozzle 109. In the movable-side unit 10, each of the operating rod 101, cylinder 102, piston 103, and movable-side contact part 105 is formed of, for example, a metal material and is electrically connected to an electric wire (not illustrated) that is supported by one of a pair of insulators.

### [A-2-1] Operating Rod 101

The operating rod 101 is, for example, a cylindrical tubular body. The operating rod 101 is connected to the operating mechanism 30 through an insulating rod 301. The operating rod 101 has an axial direction, for example, along the direction x, and is configured to move along the axial direction by the operating mechanism 30.

### [A-2-2] Cylinder 102

The cylinder 102 includes a cylinder tube part 121 and a cylinder bottom plate part 122.

The cylinder tube part 121 is, for example, a cylindrical tubular body. An inner diameter of the cylinder tube part 121 is larger than an outer diameter of the operating rod 101, and the operating rod 101 is housed in the cylinder tube part 121. The cylinder tube part 121 is arranged coaxially with the operating rod 101.

The cylinder bottom plate part 122 is, for example, a discoid plate-shaped body and is provided at an end part of the cylinder tube part 121 on a side where the opposite-side unit 20 is located. The operating rod 101 passes through a center of the cylinder bottom plate part 122. The cylinder bottom plate part 122 has a release port H102. The release port H102 axially passes through the cylinder bottom plate part 122 around the operating rod 101 passing therethrough.

The cylinder 102 and the operating rod 101 are fixed and electrically connected therebetween. The cylinder 102 is configured to slide axially of the operating rod 101 together with the operating rod 101 by the operating mechanism 30.

### [A-2-3] Piston 103

The piston 103 is housed inside the cylinder 102.

The piston 103 is, for example, a circular annular body and arranged coaxially with the operating rod 101. An outer diameter of the piston 103 is the same as an inner diameter of the cylinder 102, and the operating rod 101 passes through the piston 103, allowing the operating rod 101 to slide axially against the piston 103.

The piston 103 divides an inside of the cylinder 102 in the axial direction. In the inside of the cylinder 102, a space located on the opposite-side unit 20 side than the piston 103 is a mechanical puffer chamber PR.

The mechanical puffer chamber PR is configured so that a volume capacity changes as the cylinder 102 moves axially together with the operating rod 101. As will be described in detail below, a pressure of the arc-extinguishing gas introduced into the mechanical puffer chamber PR increases as the volume capacity of the mechanical puffer chamber PR decreases an interruption process. The arc-extinguishing gas whose pressure has increased in the mechanical puffer chamber PR is then released from the mechanical puffer chamber PR through the release port H102 of the cylinder 102.

The piston 103 is supported by a piston support 107. Although not illustrated in the figure, the piston 103 is fixed to the airtight container 1 through the piston support 107. The piston support 107 is, for example, a cylindrical tubular body and arranged coaxially with the operating rod 101. An inner diameter of the piston support 107 is larger than the outer diameter of the operating rod 101, and an outer diameter of the piston support 107 is smaller than an inner diameter of the piston 103. The piston support 107 is, for example, integrally formed with the piston 103.

### [A-2-4] Movable-Side Contact Part 105

The movable-side contact part 105 (first contact part) has a movable-side arc contact 11 and a movable-side energizing contact 12, and is configured to slide axially together with the operating rod 101 by the operating mechanism 30.

### [A-2-4-1] Movable-Side Arc Contact 11

The movable-side arc contact 11 is, for example, a cylindrical tubular body and arranged coaxially with the operating rod 101. Here, the movable-side arc contact 11 is connected to an end part of the operating rod 101 that is located on the opposite-side unit 20 side, and electrically connected to the operating rod 101. The movable-side arc contact 11 has the same diameter as the operating rod 101, for example.

In the movable-side arc contact 11, a tip portion located on the opposite-side unit 20 side is configured to expand inward. In the movable-side arc contact 11, the tip portion may be divided into a plurality of circumferential sections and configured as a flexible finger-shaped electrode.

### [A-2-4-2] Movable-Side Energizing Contact 12

The movable-side energizing contact 12 is, for example, a cylindrical tubular body, and arranged coaxially with the operating rod 101.

The movable-side energizing contact 12 includes a portion that internally houses the insulating nozzle 109 and the movable-side arc contact 11. The movable-side energizing contact 12 is fixed to the cylinder bottom plate part 122 of the cylinder 102 to surround the insulating nozzle 109 and movable-side arc contact 11, and electrically connected to the cylinder 102.

Here, the movable-side energizing contact 12 is configured so that an inner diameter of the movable-side energizing contact 12 is the same as an outer diameter of a portion of the insulating nozzle 109 that is located on the operating mechanism 30 side.

### [A-2-5] Insulating Nozzle 109

The insulating nozzle 109 is formed of an insulating material. The insulating nozzle 109 is, for example, a cylindrical tubular body and arranged coaxially with the operating rod 101 inside the airtight container 1.

The insulating nozzle 109 is fixed to the cylinder 102 and moves together with the cylinder 102 by the operating mechanism 30. The insulating nozzle 109 is configured so that the arc-extinguishing gas, whose pressure increases in the mechanical puffer chamber PR during the interruption process, is released from the mechanical puffer chamber PR to extinguish the arc discharge that occurred during the interruption process. That is, the insulating nozzle 109 and the mechanical puffer chamber PR function as a gas flow generation means.

A nozzle inner space R109 of the insulating nozzle 109 includes a first nozzle inner space part R109a, a second nozzle inner space part R109b, and a third nozzle inner space part R109c. The first nozzle inner space part R109a, the second nozzle inner space part R109b, and the third nozzle inner space part are each sequentially aligned from the movable-side unit 10 side to the opposite-side unit 20 side in the axial direction and are connected to each other.

The first nozzle inner space part R109a houses the movable-side arc contact 11. In the first nozzle inner space part R109a, a gap is interposed between the insulating nozzle 109 and the movable-side arc contact 11. The second nozzle inner space part R109b is configured to have a smaller inner diameter than the first nozzle inner space part R109a. The third nozzle inner space part R109c is configured to have a larger inner diameter than the second nozzle inner space part R109b.

### [A-3] Opposite-Side Unit 20

The opposite-side unit 20 is housed inside the airtight container 1. The opposite-side unit 20 is installed in line opposite the movable-side unit 10 inside the airtight container 1.

The opposite-side unit 20 includes a support tube 201, a support 202, and an opposite-side contact part 205. In the opposite-side unit 20, each of the support tube 201, the support 202, and the opposite-side contact part 205 is formed, for example, of a metal material and electrically connected to an electric wire (not illustrated) that is supported by the other of the pair of insulators.

### [A-3-1] Support Tube 201

The support tube 201 is, for example, a cylindrical tubular body and arranged coaxially with the operating rod 101 inside the airtight container 1. Although not illustrated in the figure, the support tube 201 is supported by the airtight container 1 inside the airtight container 1.

### [A-3-2] Support 202

The support 202 includes a support plate part 221 and a support rod part 222 and is housed inside the support tube 201. The support 202 is formed, for example, by stacking a plurality of conductor plates.

The support plate part 221 is, for example, a discoid plate-shaped body and arranged coaxially with the support tube 201.

The support rod part 222 is, for example, a columnar rod-shaped body and extends in the axial direction. The support rod part 222 is arranged coaxially with the support tube 201. The support rod part 222 is provided opposite the movable-side unit 10 side in the support plate part 221.

### [A-3-3] Opposite-Side Contact Part 205

The opposite-side contact part 205 (second contact part) includes an opposite-side arc contact 21 and an opposite-side energizing contact 22.

### [A-3-3-1] Opposite-Side Arc Contact 21

The opposite-side arc contact 21 is, for example, a columnar rod-shaped body and coaxial with the support tube 201.

The opposite-side arc contact 21 extends in the axial direction and is supported by the support 202 inside the support tube 201. Concretely, the opposite-side arc contact 21 is fixed to a surface located on the movable-side unit 10 side in the support plate part 221 forming the support 202. The opposite-side arc contact 21 may be integrally formed with the support 202.

A tip part of the opposite-side arc contact 21 located on the movable-side unit 10 side is curved and rounded.

As illustrated in FIG. 1A, when the switchgear is in the closed state (energized state), the opposite-side arc contact 21 is inserted into the nozzle inner space R109 of the insulating nozzle 109. An outer diameter of the opposite-side arc contact 21 is, for example, the same as the second nozzle inner space part R109b and smaller than the inner diameters of the first nozzle inner space part R109a and the third nozzle inner space part R109c.

The outer diameter of the opposite-side arc contact 21 is, for example, the same as an inner diameter of a tip portion of the movable-side arc contact 11. As illustrated in FIG. 1A, when the switchgear is in the closed state (energized state), it is configured such that an inner peripheral surface of the movable-side arc contact 11 and an outer peripheral surface of the opposite-side arc contact 21 are brought into contact, and both are electrically connected.

### [A-3-3-2] Opposite-Side Energizing Contact 22

The opposite-side energizing contact 22 is, for example, a cylindrical tubular body, and arranged coaxially with the support tube 201.

The opposite-side energizing contact 22 is supported by the support 202. The opposite-side energizing contact 22 houses the support plate part 221 forming the support 202 inside and is fixed to an outer peripheral surface of the support plate part 221.

A portion of the opposite-side energizing contact 22 that is located on the movable-side unit 10 side projects outward from the support tube 201. A tip of the portion of the opposite-side energizing contact 22 that is located on the movable-side unit 10 side is configured to expand inward.

A portion of the opposite-side energizing contact 22 that is located opposite the movable-side unit 10 side is housed inside the support tube 201. Here, an outer diameter of the opposite-side energizing contact 22 is approximately the same as an inner diameter of the support tube 201, and the opposite-side energizing contact 22 is configured to slide axially together with the support 202 inside the support tube 201.

In this embodiment, a sliding smooth part 211 is embedded in a portion of an inner peripheral surface of the support tube 201 that is in contact with an outer peripheral surface of the opposite-side energizing contact 22. The sliding smooth part 211 has, for example, a lower friction coefficient on its surface than the support tube 201 so that the opposite-side energizing contact 22 can slide smoothly on the inner peripheral surface of the support tube 201. The sliding smooth part 211 is formed of a conductor and electrically connects the support tube 201 and the opposite-side energizing contact 22. Further, the sliding smooth part 211 may be configured to be elastically deformable with respect to sliding of the opposite-side energizing contact 22.

An inner diameter of a tip portion of the opposite-side energizing contact 22 is, for example, the same as an outer diameter of the movable-side energizing contact 12, and when the switchgear is in the closed state (energized state), it is configured such that an outer peripheral surface of the movable-side energizing contact 12 and an inner peripheral surface of the opposite-side energizing contact 22 are brought into contact, and both are electrically connected as illustrated in FIG. 1A.

### [A-4] Operating Mechanism 30

The operating mechanism 30 is installed outside the airtight container 1. The operating mechanism 30 is, for example, a spring operating mechanism that uses a spring force to drive the movable-side contact part 105.

In this embodiment, the operating mechanism 30 moves the piston 103 and the insulating nozzle 109 in the axial direction together with the movable-side contact part 105 by operating the operating rod 101 in the axial direction.

Concretely, when executing the closing operation, the operating mechanism 30 operates so that the movable-side contact part 105 approaches the opposite-side contact part 205. As a result, the movable-side arc contact 11 and the opposite-side arc contact 21 are brought into contact, as well as the movable-side energizing contact 12 and the opposite-side energizing contact 22 are brought into contact, resulting in the closed state (energized state) where the movable-side contact part 105 and the opposite-side contact part 205 are electrically connected to each other.

In contrast, when executing the opening operation, the operating mechanism 30 operates so that the movable-side contact part 105 separates from the opposite-side contact part 205. As a result, the movable-side arc contact 11 and the opposite-side arc contact 21 are separated from each other, and the movable-side energizing contact 12 and the opposite-side energizing contact 22 are separated from each other, resulting in the open state (interruption state) where the movable-side contact part 105 and the opposite-side contact part 205 are electrically insulated.

### [A-5] Transmitting Mechanism 40

The transmitting mechanism 40 has a coupling member 401, a reversing lever 41, a connecting link 42, and a fulcrum lever 43, and is configured to transmit the driving force of the operating mechanism 30 to the opposite-side contact part 205 through the movable-side contact part 105.

### [A-5-1] Coupling Member 401

In the transmitting mechanism 40, the coupling member 401 is, for example, a columnar rod-shaped body. The coupling member 401 passes through the support plate part 221 forming the support 202 along the axial direction. One end part of the coupling member 401 that is located on the operating mechanism 30 side is fixed to the insulating nozzle 109, for example. The coupling member 401 is configured to slide axially as the insulating nozzle 109 or the like moves in the axial direction by the operating mechanism 30.

### [A-5-2] Reversing Lever 41

In the transmitting mechanism 40, the reversing lever 41 is, for example, a plate-shaped body and includes a reversing lever one end part 41A and a reversing lever other end part 41B located opposite the reversing lever one end part 41A. In addition, the reversing lever 41 also includes a reversing lever fulcrum part 41C. The reversing lever fulcrum part 41C is located between the reversing lever one end part 41A and the reversing lever other end part 41B. The reversing lever 41 passes through a support tube opening part formed on a peripheral surface part of the support tube 201, with the reversing lever one end part 41A located inside the support tube 201 and the reversing lever other end part 41B located outside the support tube 201.

### [A-5-3] Connecting Link 42

In the transmitting mechanism 40, the connecting link 42 is, for example, a plate-shaped body and includes a connecting link one end part 42A and a connecting link other end part 42B located opposite the connecting link one end part 42A. The connecting link 42 passes through the support tube opening part K201 formed on the peripheral surface part of the support tube 201, with the connecting link other end part 42B located inside the support tube 201 and the connecting link one end part 42A located outside the support tube 201.

### [A-5-4] Fulcrum Lever 43

In the transmitting mechanism 40, the fulcrum lever 43 includes a fulcrum lever one end part 43A and a fulcrum lever other end part 43B located opposite the fulcrum lever one end part 43A. The fulcrum lever 43 is arranged inside a portion of the support tube 201 where the support tube opening part K201 is formed.

### [A-5-5] Connection of Each End Part

The reversing lever one end part 41A is rotatably connected to the opposite-side contact part 205 through the support 202. Here, the reversing lever one end part 41A is rotatably connected to an end part of the support rod part 222 forming the support 202 located opposite the operating mechanism 30 side.

The reversing lever other end part 41B and the connecting link one end part 42A are rotatably connected.

The connecting link other end part 42B is rotatably connected to the movable-side contact part 105 through the coupling member 401. Here, the connecting link other end part 42B is rotatably connected to the end part of the coupling member 401 located opposite the operating mechanism 30 side.

The fulcrum lever one end part 43A is rotatably connected to the support tube 201. The fulcrum lever other end part 43B is rotatably connected to the reversing lever fulcrum part 41C.

The reversing lever one end part 41A, the reversing lever other end part 41B, the connecting link one end part 42A, the connecting link other end part 42B, the fulcrum lever one end part 43A, and the fulcrum lever other end part 43B are each provided to rotate with a rotation axis perpendicular to the axial direction (direction y in the figure).

### [B] Operation of Switchgear

Operation of the switchgear in this embodiment will be concretely described.

### [B-1] Closing Operation (Turn-on Operation)

First, the closing operation (turn-on operation) is explained. The closing operation is executed by a controller (not illustrated) controlling the operation of the operating mechanism 30 based on a turn-on command.

After the closing operation is executed in the switchgear, the switchgear is in the closed state (energized state), as already illustrated in FIG. 1A.

When the switchgear is in the closed state, the movable-side arc contact 11 and the opposite-side arc contact 21 are in the contact state, as well as the movable-side energizing contact 12 and the opposite-side energizing contact 22 are in the contact state. When the switchgear is in the closed state, the support tube 201, the opposite-side energizing contact 22, the movable-side energizing contact 12, and the cylinder 102 are electrically connected and current flows.

### [B-2] Opening Operation (Interruption Operation)

Next, the opening operation (interruption operation) is explained. The opening operation is executed by the controller (not illustrated in the figure) controlling the operation of the operating mechanism 30 based on an interruption command. The opening operation is executed, for example, to interrupt fault currents or the like.

FIG. 1B and FIG. 1C are sectional views each schematically illustrating a state when the opening operation (interruption operation) is executed in the switchgear of the first embodiment. FIG. 1B illustrates the state of the interruption process during the state changes to the open state (interruption state) when the opening operation (interruption operation) is executed. FIG. 1C illustrates the state after the execution of the opening operation (interruption operation) is completed and the open state (interruption state) is reached.

As illustrated in FIG. 1B and FIG. 1C, when the opening operation is executed in the switchgear to bring the switchgear from the closed state (energized state) to the open state (interruption state), the state between the movable-side energizing contact 12 and the opposite-side energizing contact 22 goes from the contact state to the separated state. Thereafter, the state between the movable-side arc contact 11 and the opposite-side arc contact 21 goes from the contact state to the separated state.

When the movable-side arc contact 11 and the opposite-side arc contact 21 are separated in the nozzle inner space R109 of the insulating nozzle 109, arc discharge (not illustrated) occurs between the movable-side arc contact 11 and the opposite-side arc contact 21. In the switchgear, the cylinder 102 moves around the piston 103 as the opening operation proceeds. As a result, the volume capacity of the mechanical puffer chamber PR inside the cylinder 102 decreases, and the pressure of the arc-extinguishing gas introduced into the mechanical puffer chamber PR increases. The arc-extinguishing gas is then injected from the mechanical puffer chamber PR into the nozzle inner space R109 of the insulating nozzle 109 through the release port H102. As a result, the arc discharge (not illustrated) that occurs between the movable-side arc contact 11 and the opposite-side arc contact 21 in the nozzle inner space R109 is extinguished by the arc-extinguishing gas injected from the release port H102. The arc discharge is extinguished when a current zero point is reached and the opening operation is completed.

In the switchgear of this embodiment, the transmitting mechanism 40 transmits the driving force of the operating mechanism 30 to the opposite-side contact part 205 through the movable-side contact part 105, as described above. As a result, when the opening operation is executed in this embodiment, the movable-side contact part 105 moves to the operating mechanism 30 side in the axial direction (right side in the figure), and the opposite-side contact part 205 moves to the opposite side of the operating mechanism 30 in the axial direction (left side in the figure).

### [B-2-1] Operation of Coupling Member 401

In the transmitting mechanism 40, the coupling member 401 moves to the operating mechanism 30 side in the axial direction as the movable-side contact part 105 moves, and the connecting link other end part 42B of the connecting link 42 connected to the coupling member 401 also moves to the operating mechanism 30 side in the axial direction.

### [B-2-2] Operation of Reversing Lever 41

In the transmitting mechanism 40, the reversing lever 41 rotates and moves in a counterclockwise direction (first rotational direction) using the portion where the fulcrum lever other end part 43B and the reversing lever fulcrum part 41C are rotatably connected as a rotation center, as the connecting link other end part 42B moves. As a result, the reversing lever other end part 41B moves to the operating mechanism 30 side and the reversing lever one end part 41A moves to the opposite side of the operating mechanism 30 in the reversing lever 41.

As the reversing lever one end part 41A moves, the support 202 moves to the opposite side of the operating mechanism 30 side in the axial direction. As a result, the opposite-side contact part 205 supported by the support 202 also moves to the opposite side of the operating mechanism 30 in the axial direction. That is, the opposite-side contact part 205 moves to the opposite side of the movable-side contact part 105 in the axial direction.

### [B-2-3] Operation of Connecting Link 42

In the transmitting mechanism 40, the connecting link 42 rotates using the portion where the connecting link other end part 42B is rotatably connected to the support 202 as a rotation center axis, as the coupling member 401 moves.

Here, the connecting link 42 first rotates and moves in the counterclockwise direction using the portion where the connecting link other end part 42B is rotatably connected to the support 202 as the rotation center axis. As a result, the connecting link one end part 42A moves to the operating mechanism 30 side in the axial direction, and also moves from the inside to the outside in a radial direction (see FIG. 1A and FIG. 1B) in the connecting link 42.

The connecting link 42 then rotates and moves in a clockwise direction (second rotational direction) opposite to the counterclockwise direction using the portion where the connecting link other end part 42B is rotatably connected to the support 202 as the rotation center axis. As a result, the connecting link one end part 42A moves to the operating mechanism 30 side in the axial direction, and also moves from the outside to the inside in the radial direction (see FIG. 1B and FIG. 1C) in the connecting link 42.

### [B-2-4] Operation of Fulcrum Lever 43

In the transmitting mechanism 40, the fulcrum lever 43 rotates using the portion where the fulcrum lever one end part 43A is rotatably connected to the support tube 201 as the rotation center axis, as the coupling member 401 moves.

Here, the fulcrum lever 43 first rotates and moves in the counterclockwise direction using the portion where the fulcrum lever one end part 43A is rotatably connected to the support tube 201 as the rotation center axis. As a result, the fulcrum lever other end part 43B moves from the inside to the outside in the radial direction (see FIG. 1A and FIG. 1B) in the fulcrum lever 43.

The fulcrum lever 43 then rotates and moves in the clockwise direction opposite to the counterclockwise direction using the portion where the fulcrum lever one end part 43A is rotatably connected to the support tube 201 as the rotation center axis. As a result, in the fulcrum lever 43, the fulcrum lever other end part 43B moves from the outside to the inside in the radial direction (see FIG. 1B and FIG. 1C).

### [C] Summary

As described above, the switchgear of this embodiment has the transmitting mechanism 40 so that the driving force of the operating mechanism 30 is transmitted to the opposite-side contact part 205 through the movable-side contact part 105. The transmitting mechanism 40 transmits the driving force of the operating mechanism 30 to the opposite-side contact part 205 so that a moving direction of the opposite-side contact part 205 is opposite to that of the movable-side contact part 105. Therefore, in this embodiment, a relative movement speed of the movable-side contact part 105 relative to the opposite-side side contact part 205 can be increased even when the driving force of the operating mechanism 30 is relatively low.

In the switchgear of this embodiment, the transmitting mechanism 40 has the reversing lever 41, the connecting link 42, and the fulcrum lever 43, as described above. The reversing lever 41 includes the reversing lever one end part 41A, the reversing lever other end part 41B located opposite the reversing lever one end part 41A, and the reversing lever fulcrum part 41C located between the reversing lever one end part 41A and the reversing lever other end part 41B. The connecting link 42 includes the connecting link one end part 42A and the connecting link other end part 42B located opposite the connecting link one end part 42A. The fulcrum lever 43 includes the fulcrum lever one end part 43A and the fulcrum lever other end part 43B located opposite the fulcrum lever one end part 43A. Here, the reversing lever one end part 41A is rotatably connected to the opposite-side contact part 205 through the support 202, the reversing lever other end part 41B and the connecting link one end part 42A are rotatably connected, and the connecting link other end part 42B is rotatably connected to the movable-side contact part 105. The fulcrum lever one end part 43A is rotatably connected to the airtight container 1 through the support tube 201, and the fulcrum lever other end part 43B is rotatably connected to the reversing lever fulcrum part 41C.

When the opening operation (interruption operation) or the like is performed in this embodiment, the reversing lever 41 rotates so that the reversing lever other end part 41B approaches the movable-side unit 10 side using the reversing lever one end part 41A as the rotation center in the transmitting mechanism 40. At this time, a force acts on the opposite-side contact part 205 in a direction perpendicular to the moving direction of the opposite-side contact part 205 (in this case, a longitudinal direction) through the support 202. Due to a component in the direction perpendicular to the moving direction of the opposite-side contact part 205, frictional forces at the sliding portions in the movable-side contact part 105 and the opposite-side contact part 205 increase, which may make smooth operation difficult.

However, the transmitting mechanism 40 of this embodiment includes the fulcrum lever 43, with the fulcrum lever one end part 43A rotatably connected to the airtight container 1 through the support tube 201 and the fulcrum lever other end part 43B rotatably connected to the reversing lever fulcrum part 41C of the reversing lever 41. Therefore, in this embodiment, the fulcrum lever 43 follows the rotation of the reversing lever 41, with the fulcrum lever other end part 43B rotating using the fulcrum lever one end part 43A as the rotation center. In other words, the rotation of the fulcrum lever 43 is caused by the action of the component in the direction perpendicular to the moving direction of the opposite-side contact part 205. As a result, the component in the direction perpendicular to the moving direction of the opposite-side contact part 205 reduces the forces acting on the sliding portions in the movable-side contact part 105 and the opposite-side contact part 205.

Therefore, in the switchgear of this embodiment, it is possible to prevent an increase in the frictional forces at the sliding portions, which makes it easy to achieve high-speed operation.

### Second Embodiment

### [A] Configuration of Switchgear

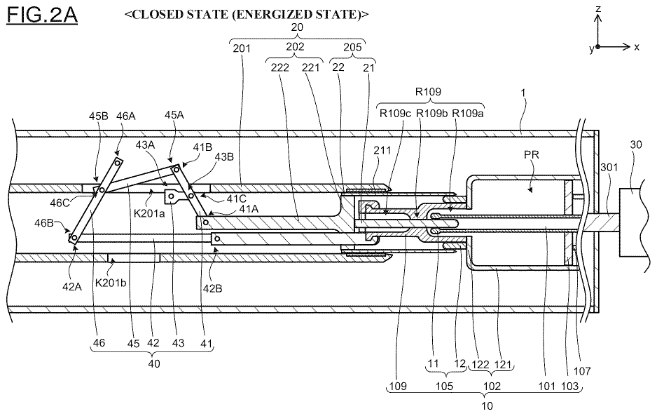

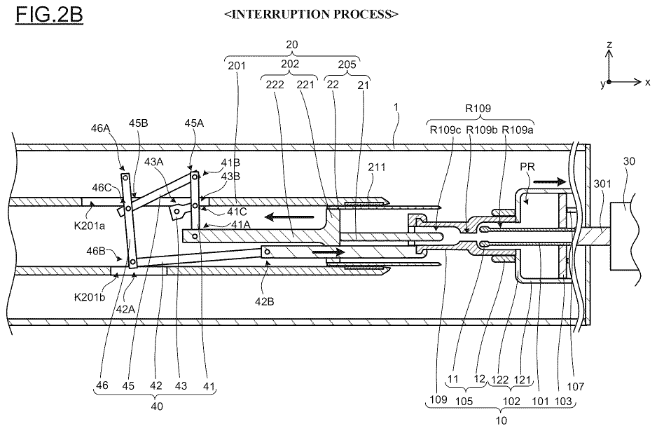

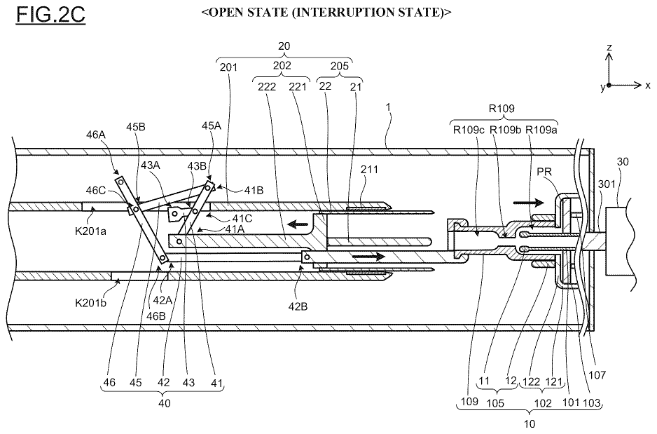

FIG. 2A is a sectional view schematically illustrating a configuration of a switchgear in a second embodiment. In FIG. 2A, a state when the switchgear is in a closed state (energized state) is illustrated as in FIG. 1A.

In the switchgear of this embodiment, a configuration of the transmitting mechanism 40 is different from the case of the first embodiment (see FIG. 1A) as illustrated in FIG. 2A. Except for this point and related matters, this embodiment is similar to the case of the first embodiment. For this reason, explanations of duplicated matters will be omitted as appropriate.

In the switchgear of this embodiment, the transmitting mechanism 40 has the coupling member 401, the reversing lever 41, the connecting link 42 (first connecting link), the fulcrum lever 43, a connecting link 45 (second connecting link), and a conversion lever 46, and is configured to transmit the driving force of the operating mechanism 30 to the opposite-side contact part 205 through the movable-side contact part 105, as illustrated in FIG. 2A.

### [A-1] Coupling Member 401

In the transmitting mechanism 40, the coupling member 401 is configured as in the first embodiment.

### [A-2] Reversing Lever 41

In the transmitting mechanism 40, the reversing lever 41 is, for example, a plate-shaped body and includes the reversing lever one end part 41A and the reversing lever other end part 41B located opposite the reversing lever one end part 41A. In addition, the reversing lever 41 also includes the reversing lever fulcrum part 41C. The reversing lever fulcrum part 41C is located between the reversing lever one end part 41A and the reversing lever other end part 41B. The reversing lever 41 passes through the support tube opening part K201a formed on the peripheral surface part of the support tube 201, with the reversing lever one end part 41A located inside the support tube 201 and the reversing lever other end part 41B located outside the support tube 201.

### [A-3] Connecting Link 42 (First Connecting Link)

In the transmitting mechanism 40, the connecting link 42 (first connecting link) is, for example, a plate-shaped body and includes the connecting link one end part 42A and the connecting link other end part 42B located opposite the connecting link one end part 42A. The connecting link 42 is housed inside the support tube 201.

### [A-4] Fulcrum Lever 43

In the transmitting mechanism 40, the fulcrum lever 43 includes the fulcrum lever one end part 43A and the fulcrum lever other end part 43B located opposite the fulcrum lever one end part 43A. The fulcrum lever 43 is arranged inside the portion where the support tube opening part K201a is formed at the support tube 201.

### [A-5] Connecting Link 45 (Second Connecting Link)

In the transmitting mechanism 40, the connecting link 45 (second connecting link) includes a connecting link one end part 45A (second connecting link one end part) and a connecting link other end part 45B (second connecting link other end part) located opposite the connecting link one end part 45A. The connecting link 45 passes through the support tube opening part K201a formed at the peripheral surface part of the support tube 201, with the connecting link one end part 45A located inside the support tube 201 and the connecting link other end part 45B located outside the support tube 201.

### [A-6] Conversion Lever 46

In the transmitting mechanism 40, the conversion lever 46 includes a conversion lever one end part 46A and a conversion lever other end part 46B located opposite the conversion lever one end part 46A. The conversion lever 46 also includes a conversion lever fulcrum part 46C located between the conversion lever one end part 46A and the conversion lever other end part 46B. In the conversion lever 46, the conversion lever other end part 46B is housed inside the support tube 201.

### [A-7] Connection of Each End Part

The reversing lever one end part 41A is rotatably connected to the opposite-side contact part 205 through the support 202. Here, the reversing lever one end part 41A is rotatably connected to the end part of the support rod part 222 forming the support 202 located opposite the operating mechanism 30 side.

The reversing lever other end part 41B and the connecting link one end part 45A are rotatably connected, and the connecting link other end part 45B and the conversion lever fulcrum part 46C are rotatably connected. In addition, the conversion lever other end part 46B and the connecting link other end part 42B are rotatably connected.

The connecting link other end part 42B is rotatably connected to the movable-side contact part 105 through the coupling member 401. Here, the connecting link other end part 42B is rotatably connected to the end part of the coupling member 401 located opposite the operating mechanism 30 side.

The conversion lever one end part 46A is rotatably connected to the airtight container 1 in a space that is located outside the support tube 201 inside the airtight container 1.

The fulcrum lever one end part 43A is rotatably connected to the support tube 201. The fulcrum lever other end part 43B is rotatably connected to the reversing lever fulcrum part 41C.

The reversing lever one end part 41A, the reversing lever other end part 41B, the connecting link one end part 42A, the connecting link other end part 42B, the fulcrum lever one end part 43A, the fulcrum lever other end part 43B, the connecting link one end part 45A, the connecting link other end part 45B, the conversion lever one end part 46A, and the conversion lever other end part 46B are each provided to rotate with a rotation axis perpendicular to the axial direction (direction y in the figure).

### [B] Operation of Switchgear

Operation of the switchgear in this embodiment will be concretely explained.

### [B-1] Closing Operation (Turn-on Operation)

First, the closing operation (turn-on operation) is explained.

After the closing operation is executed in the switchgear of this embodiment, the switchgear becomes in the closed state (energized state) as in the case of the first embodiment (see FIG. 1A), as already illustrated in FIG. 2A. That is, the movable-side arc contact 11 and the opposite-side arc contact 21 are brought into contact, as well as the movable-side energizing contact 12 and the opposite-side energizing contact 22 are brought into contact. As a result, the support tube 201, the opposite-side energizing contact 22, the movable-side energizing contact 12, and the cylinder 102 are electrically connected and current flows in the switchgear.

### [B-2] Opening Operation (Interruption Operation)

Next, the opening operation (interruption operation) is explained.

FIG. 2B and FIG. 2C are sectional views each schematically illustrating a state when the opening operation (interruption operation) is executed in the switchgear of the second embodiment. FIG. 2B illustrates the state of the interruption process during the state changes to the open state (interruption state) when the opening operation (interruption operation) is executed as in FIG. 1B. FIG. 2C illustrates the state after the execution of the opening operation (interruption operation) is completed and the open state (interruption state) is reached as in FIG. 1C.

As illustrated in FIG. 2B and FIG. 2C, when the opening operation is executed in the switchgear of this embodiment to bring the switchgear from the closed state (energized state) to the open state (interruption state), the state between the movable-side energizing contact 12 and the opposite-side energizing contact 22 goes from the contact state to the separated state as in the first embodiment. Thereafter, the state between the movable-side arc contact 11 and the opposite-side arc contact 21 goes from the contact state to the separated state.

In the switchgear of this embodiment, the transmitting mechanism 40 transmits the driving force of the operating mechanism 30 to the opposite-side contact part 205 through the movable-side contact part 105, as in the case of the first embodiment. As a result, when the opening operation is executed, the movable-side contact part 105 moves to the operating mechanism 30 side (right side in the figure) in the axial direction, and the opposite-side contact part 205 moves to the opposite side of the operating mechanism 30 (left side in the figure) in the axial direction in this embodiment.

### [B-2-1] Operation of Coupling Member 401

In the transmitting mechanism 40, the coupling member 401 moves to the operating mechanism 30 side in the axial direction as the movable-side contact 105 moves, and the connecting link other end part 42B of the connecting link 42 connected to the coupling member 401 also moves to the operating mechanism 30 side in the axial direction.

### [B-2-2] Operation of Reversing Lever 41

In the transmitting mechanism 40 of this embodiment, the reversing lever 41 is driven in conjunction with the connecting link 45 and the conversion lever 46, in addition to the connecting link 42. Here, the reversing lever 41 rotates and moves in the clockwise direction using the portion where the fulcrum lever other end part 43B and the reversing lever fulcrum part 41C are rotatably connected as the rotation center, as the connecting link other end part 42B moves. As a result, the reversing lever other end part 41B moves to the operating mechanism 30 side and the reversing lever one end part 41A moves to the opposite side of the operating mechanism 30 in the reversing lever 41.

As the reversing lever one end part 41A moves, the support 202 moves to the opposite side of the operating mechanism 30 in the axial direction. As a result, the opposite-side contact part 205 supported by the support 202 also moves to the opposite side of the operating mechanism 30 in the axial direction. That is, the opposite-side contact part 205 moves to the opposite side of the movable-side contact part 105 in the axial direction.

### [B-2-3] Operation of Connecting Link 42

In the transmitting mechanism 40, the connecting link 42 rotates using the portion where the connecting link other end part 42B is rotatably connected to the support 202 as the rotation center axis, as the coupling member 401 moves.

Here, the connecting link 42 first rotates and moves in the counterclockwise direction using the portion where the connecting link other end part 42B is rotatably connected to the support 202 as the rotation center axis. As a result, the connecting link one end part 42A moves to the operating mechanism 30 side in the axial direction, and also moves from the inside to the outside in the radial direction (see FIG. 2A and FIG. 2B) in the connecting link 42.

The connecting link 42 then rotates and moves in the clockwise direction using the portion where the connecting link other end part 42B is rotatably connected to the support 202 as the rotation center axis. As a result, the connecting link one end part 42A moves to the operating mechanism 30 side in the axial direction, and also moves from the outside to the inside in the radial direction (see FIG. 2B and FIG. 2C) in the connecting link 42.

### [B-2-4] Operation of Fulcrum Lever 43

In the transmitting mechanism 40, the fulcrum lever 43 rotates using the portion where the fulcrum lever one end part 43A is rotatably connected to the support tube 201 as the rotation center axis, as the coupling member 401 moves.

Here, the fulcrum lever 43 first rotates and moves in the counterclockwise direction using the portion where the fulcrum lever one end part 43A is rotatably connected to the support tube 201 as the rotation center axis. As a result, the fulcrum lever other end part 43B moves from the inside to the outside in the radial direction (see FIG. 2A and FIG. 2B) in the fulcrum lever 43.

The fulcrum lever 43 then rotates and moves in the clockwise direction using the portion where the fulcrum lever one end part 43A is rotatably connected to the support tube 201 as the rotation center axis. As a result, the fulcrum lever other end part 43B moves from the outside to the inside in the radial direction (see FIG. 2B and FIG. 2C) in the fulcrum lever 43.

### [B-2-5] Operation of Connecting Link 45 (Second Connecting Link)

In the transmitting mechanism 40, the connecting link 45 (second connecting link) rotates using the portion where the connecting link one end part 45A is rotatably connected to the reversing lever 41 as the rotation center axis, as the coupling member 401 moves.

Here, the connecting link 45 first rotates and moves in the counterclockwise direction using the portion where the connecting link one end part 45A is rotatably connected to the reversing lever 41 as the rotation center axis. As a result, the connecting link other end part 45B moves to the operating mechanism 30 side in the axial direction, and also moves from the outside to the inside in the radial direction (see FIG. 2A and FIG. 2B) in the connecting link 45.

The connecting link 45 then rotates and moves in the clockwise direction using the portion where the connecting link one end part 45A is rotatably connected to the reversing lever 41 as the rotation center axis. As a result, the connecting link other end part 45B moves to the operating mechanism 30 side in the axial direction, and also moves from the inside to the outside in the radial direction (see FIG. 2B and FIG. 2C) in the connecting link 45.

### [B-2-6] Operation of Conversion Link 46

In the transmitting mechanism 40, the conversion lever 46 rotates using the portion where the conversion lever one end part 46A is rotatably connected to the airtight container 1 as the rotation center axis, as the coupling member 401 moves.

Here, the conversion lever 46 rotates and moves in the counterclockwise direction using the portion where the conversion lever one end part 46A is rotatably connected to the airtight container 1 as the rotation center axis. As a result, the conversion lever other end part 46B and the conversion lever fulcrum part 46C move to the operating mechanism 30 side in the axial direction, and also move in the radial direction (see FIG. 2A to FIG. 2C) in the conversion lever 46.

### [C] Summary

As described above, the switchgear of this embodiment has the transmitting mechanism 40 so that the driving force of the operating mechanism 30 is transmitted to the opposite-side contact part 205 through the movable-side contact part 105, as in the first embodiment. The transmitting mechanism 40 transmits the driving force of the operating mechanism 30 to the opposite-side contact part 205 so that the moving direction of the opposite-side contact part 205 is opposite to that of the movable-side contact part 105. Therefore, in this embodiment, a relative movement speed of the movable-side contact part 105 relative to the opposite-side contact part 205 can be increased even when the driving force of the operating mechanism 30 is relatively low.

In the switchgear of this embodiment, the transmitting mechanism 40 has the reversing lever 41, the connecting link 42, the fulcrum lever 43, the connecting link 45, and the conversion lever 46, as described above. The reversing lever 41 includes the reversing lever one end part 41A, the reversing lever other end part 41B located opposite the reversing lever one end part 41A, and the reversing lever fulcrum part 41C located between the reversing lever one end part 41A and the reversing lever other end part 41B. The connecting link 42 includes the connecting link one end part 42A and the connecting link other end part 42B located opposite the connecting link one end part 42A. The fulcrum lever 43 includes the fulcrum lever one end part 43A and the fulcrum lever other end part 43B located opposite the fulcrum lever one end part 43A. The connecting link 45 includes the connecting link one end part 45A and the connecting link other end part 45B located opposite the connecting link one end part 45A. The conversion lever 46 includes the conversion lever one end part 46A, the conversion lever other end part 46B located opposite the conversion lever one end part 46A, and the conversion lever fulcrum part 46C located between the conversion lever one end part 46A and the conversion lever other end part 46B. The reversing lever one end part 41A is rotatably connected to the opposite-side contact part 205 through the support 202, and the reversing lever other end part 41B and the connecting link one end part 45A are rotatably connected. The connecting link other end part 45B and the conversion lever fulcrum part 46C are rotatably connected, and the conversion lever other end part 46B and the connecting link other end part 42B are rotatably connected. The connecting link other end part 42B is rotatably connected to the movable-side contact part 105 through the coupling member 401. The conversion lever one end part 46A is rotatably connected to the airtight container 1. The fulcrum lever one end part 43A is rotatably connected to the airtight container 1 through the support tube 201. The fulcrum lever other end part 43B is rotatably connected to the reversing lever fulcrum part 41C.

As in the first embodiment, the transmitting mechanism 40 of this embodiment includes the fulcrum lever 43, wherein the fulcrum lever one end part 43A is rotatably connected to the airtight container 1 through the support tube 201 and the fulcrum lever other end part 43B is rotatably connected to the reversing lever fulcrum part 41C of the reversing lever 41. Thus, the component in the direction perpendicular to the moving direction of the opposite-side contact part 205 reduces the forces acting on the sliding portions in the movable-side contact part 105 and the opposite-side contact part 205 also in this embodiment.

Therefore, in the switchgear of this embodiment, it is possible to prevent an increase in the frictional forces at the sliding portions, which makes it easy to achieve high-speed operation.

In addition, in the switchgear of this embodiment, a length (diameter) of the airtight container 1 in the radial direction can be set shorter than in the case of the first embodiment because each part of the transmitting mechanism 40 is configured as described above. As a result, the switchgear of this embodiment can achieve a smaller size than in the case of the first embodiment, and a volume of arc-extinguishing gas to be sealed in the airtight container 1 can be reduced.

### <Others>

While certain embodiments have been described, these embodiments have been presented by way of example only, and are not intended to limit the scope of the inventions. Indeed, the embodiments described herein may be embodied in a variety of other forms; furthermore, various omissions, substitutions, and changes in the form of the embodiments described herein may be made without departing from the spirit of the inventions. The accompanying claims and their equivalents are intended to cover such embodiments or modifications as would fall within the scope and spirit of the inventions.

For example, in the above embodiments, the case in which the switchgear is a puffer-type gas-blast circuit breaker is illustrated, but it is not limited to the case. The above transmitting mechanism may be applied to a switchgear other than the puffer-type gas-blast circuit breaker.

### EXPLANATION OF REFERENCE SIGNS

1 . . . airtight container, 10 . . . movable-side unit, 11 . . . movable-side arc contact, 12 . . . movable-side energizing contact, 20 . . . opposite-side unit, 21 . . . opposite-side arc contact, 22 . . . opposite-side energizing contact, 30 . . . operating mechanism, 40 . . . transmitting mechanism, 41 . . . reversing lever, 41A . . . reversing lever one end part, 41B . . . reversing lever other end part, 41C . . . reversing lever fulcrum part, 42 . . . connecting link, 42A . . . connecting link one end part, 42B . . . connecting link other end part, 43 . . . fulcrum lever, 43A . . . fulcrum lever one end part, 43B . . . fulcrum lever other end part, 45 . . . connecting link, 45A . . . connecting link one end part, 45B . . . connecting link other end part, 46 . . . conversion lever, 46A . . . conversion lever one end part, 46B . . . conversion lever other end part, 46C . . . conversion lever fulcrum part, 101 . . . operating rod, 102 . . . cylinder, 103 . . . piston, 105 . . . movable-side contact part, 107 . . . piston support, 109 . . . insulating nozzle, 121 . . . cylinder tube part, 122 . . . cylinder bottom plate part, 201 . . . support tube, 202 . . . support, 205 . . . opposite-side contact part, 211 . . . sliding smooth part, 221 . . . support plate part, 222 . . . support rod part, 301 . . . insulating rod, 401 . . . coupling member, H102 . . . release port, K201 . . . support tube opening part, K201a . . . support tube opening part, PR . . . mechanical puffer chamber, R109 . . . nozzle inner space, R109a . . . first nozzle inner space part, R109b . . . second nozzle inner space part, R109c . . . third nozzle inner space part

What is claimed is:

1. A switchgear which executes a closing operation to bring an electric circuit from an open state to a closed state and an opening operation to bring the electric circuit from the closed state to the open state, the switchgear comprising:
an airtight container;
a first contact part housed inside the airtight container;
a second contact part installed in line opposite the first contact part inside the airtight container;
an operating mechanism for driving the first contact part to make the first contact part approach the second contact part when executing the closing operation and make the first contact part separate from the second contact part when executing the opening operation; and
a transmitting mechanism for transmitting a driving force of the operating mechanism to the second contact part through the first contact part to make the second contact part approach the first contact part when executing the closing operation and make the second contact part separate from the first contact part when executing the opening operation, wherein
the transmitting mechanism has:
a reversing lever including a reversing lever one end part, a reversing lever other end part located opposite the reversing lever one end part, and a reversing lever fulcrum part located between the reversing lever one end part and the reversing lever other end part;
a connecting link including a connecting link one end part and a connecting link other end part located opposite the connecting link one end part; and
a fulcrum lever including a fulcrum lever one end part and a fulcrum lever other end part located opposite the fulcrum lever one end part, wherein
the reversing lever one end part is rotatably connected to the second contact part,
the reversing lever other end part and the connecting link one end part are rotatably connected,
the connecting link other end part is rotatably connected to the first contact part,
the fulcrum lever one end part is rotatably connected to the airtight container, and
the fulcrum lever other end part is rotatably connected to the reversing lever fulcrum part.

2. A switchgear which executes a closing operation to bring an electric circuit from an open state to a closed state and an opening operation to bring the electric circuit from the closed state to the open state, the switchgear comprising:
an airtight container;
a first contact part housed inside the airtight container;
a second contact part installed in line opposite the first contact part inside the airtight container;
an operating mechanism for driving the first contact part to make the first contact part approach the second contact part when executing the closing operation and make the first contact part separate from the second contact part when executing the opening operation; and
a transmitting mechanism for transmitting a driving force of the operating mechanism to the second contact part through the first contact part to make the second contact part approach the first contact part when executing the closing operation and make the second contact part separate from the first contact part when executing the opening operation, wherein
the transmitting mechanism has:
a reversing lever including a reversing lever one end part, a reversing lever other end part located opposite the reversing lever one end part, and a reversing lever fulcrum part located between the reversing lever one end part and the reversing lever other end part;
a first connecting link including a first connecting link one end part and a first connecting link other end part located opposite the first connecting link one end part;
a fulcrum lever including a fulcrum lever one end part and a fulcrum lever other end part located opposite the fulcrum lever one end part,
a second connecting link including a second connecting link one end part and a second connecting link other end part located opposite the second connecting link one end part; and
a conversion lever including a conversion lever one end part, a conversion lever other end part located opposite the conversion lever one end part, and a conversion lever fulcrum part located between the conversion lever one end part and the conversion lever other end part; wherein
the reversing lever one end part is rotatably connected to the second contact part,
the reversing lever other end part and the second connecting link one end part are rotatably connected,
the second connecting link other end part is rotatably connected to the conversion lever fulcrum part,
the conversion lever other end part and the first connecting link other end part are rotatably connected,
the first connecting link other end part is rotatably connected to the first contact part,
the conversion lever one end part is rotatably connected to the airtight container,
the fulcrum lever one end part is rotatably connected to the airtight container, and
the fulcrum lever other end part is rotatably connected to the reversing lever fulcrum part.
